(19) United States
(12) Patent Application Publication
(10) Pub. No.: US 2017/0280498 A1
(43) Pub. Date: Sep. 28, 2017

(54) OPPORTUNISTIC WAKE-UP TRANSMISSIONS VIA TIME-DIVISION MULTIPLEXING IN OFDMA-BASED 802.11AX

(71) Applicant: INTEL CORPORATION, SANTA CLARA, CA (US)

(72) Inventors: Alexander W. MIN, Portland, OR (US); Shahrnaz AZIZI, Cupertino, CA (US); Minyoung PARK, Portland, OR (US); Thomas J. KENNEY, Portland, OR (US)

(21) Appl. No.: 15/081,029

(22) Filed: Mar. 25, 2016

(51) Int. Cl. H04W 76/04; H04L 5/00

(52) U.S. Cl. CPC H04W 76/046; H04L 5/0007

(57) ABSTRACT

Mobile platform power management is an important problem especially for battery-powered small form factor platforms such as smartphones, tablets, wearable devices, Internet of Things (TOT) devices, and the like. A wake-up packet scheduler, a packet manager and a padding manager interact and cooperate to insert at least one wake-up packet on a sub-channel in a padding area after a data frame, the wake-up packet usable by a low-power wake-up radio in, for example, an IEEE 802.11 wireless communication environment.

### TECHNICAL FIELD

An exemplary aspect is directed toward communications systems. More specifically an exemplary aspect is directed toward wireless communications systems and even more specifically to low-power wake-up radios and the associated power management and power savings in wireless communications systems.

### BACKGROUND

Wireless networks are ubiquitous and are commonplace indoors and becoming more frequently installed outdoors and in shared locations. Wireless networks transmit and receive information utilizing varying techniques and protocols. For example, but not by way of limitation, two common and widely adopted techniques used for communication are those that adhere to the Institute for Electronic and Electrical Engineers (IEEE) 802.11 standards such as the IEEE 802.11n standard, the IEEE 802.11ac standard and the IEEE 802.11ax standard.

The IEEE 802.11 standards specify a common Medium Access Control (MAC) Layer which provides a variety of functions that support the operation of IEEE 802.11-based Wireless LANs (WLANs) and devices. The MAC Layer manages and maintains communications between IEEE 802.11 stations (such as between radio network interface cards (NIC) in a PC or other wireless device(s) or stations (STA) and access points (APs)) by coordinating access to a shared radio channel and utilizing protocols that enhance communications over a wireless medium.

IEEE 802.11ax is the successor to 802.11ac and is proposed to increase the efficiency of WLAN networks, especially in high density areas like public hotspots and other dense traffic areas. IEEE 802.11ax also uses orthogonal frequency-division multiple access (OFDMA), and related to IEEE 802.11ax, the High Efficiency WLAN Study Group (HEW SG) within the IEEE 802.11 working group is considering improvements to spectrum efficiency to enhance system throughput/area in high density scenarios of APs (Access Points) and/or STAs (Stations).

Bluetooth® is a wireless technology standard adapted to exchange data over, for example, short distances using short-wavelength UHF radio waves in the ISM band from 2.4 to 2.485 GHz. Bluetooth® is commonly used to communicate information from fixed and mobile devices and for building personal area networks (PANs). Bluetooth® Low Energy (BLE), also known as Bluetooth® Smart®, utilizes less power than Bluetooth® but is able to communicate over the same range as Bluetooth®.

Wi-Fi (IEEE 802.11) and Bluetooth® are somewhat complementary in their applications and usage. Wi-Fi is usually access point-centric, with an asymmetrical client-server connection with all traffic routed through the access point (AP), while Bluetooth® is typically symmetrical, between two Bluetooth® devices. Bluetooth® works well in simple situations where two devices connect with minimal configuration like the press of a button, as seen with remote controls, between devices and printers, and the like. Wi-Fi tends to operate better in applications where some degree of client configuration is possible and higher speeds are required, especially for network access through, for example, an access node. However, Bluetooth® access points do exist and ad-hoc connections are possible with Wi-Fi though not as simply configured as Bluetooth®.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a Low-Power Wake-Up Radio (LP-WUR) in a no data being received environment, and the corresponding states of the Low-Power Wake-Up receiver and main radio;

FIG. 2 illustrates a Low-Power Wake-Up Radio (LP-WUR) that is receiving data and the corresponding states of the Low-Power Wake-Up receiver and main radio;

FIG. 3 illustrates a functional block diagram of a wireless device, such as a mobile device;

FIG. 4 illustrates a hardware block diagram of an exemplary wireless device, such as a mobile device;

FIG. 5 illustrates a convention packet/frame structure;

FIG. 6 illustrates an exemplary packet/frame structure;

FIG. 7 illustrates a second exemplary packet/frame structure;

FIG. 8 illustrates a third exemplary packet/frame structure;

FIG. 9 illustrates a fourth exemplary packet/frame structure;

FIG. 10 illustrates an exemplary frame format; and

FIG. 11 is a flowchart illustrating an exemplary method of wake-up packet usage.

### DESCRIPTION OF EMBODIMENTS

Mobile platform power management is one critical aspect of battery-powered small form factor platforms such as smartphones, tablets, wearables and IoT devices. Most mobile platform workloads are communication driven and the wireless radio is often one of the main sources of the platform's power consumption.

Small computing devices such as wearable devices and sensors, mobile devices, Internet of Things (IoT) devices, and the like, are also all constrained by their small battery capacity/size, but still need to support wireless communication technologies such as Wi-Fi, Bluetooth®, Bluetooth® Low Energy (BLE), or the like, or in general any wireless technology. The wireless connectivity can be used to connect to other computing devices, such as smartphones, tablets, computers, the cloud, and the like, and exchange data. These communications consume power and it is critical to reduce, minimize or optimize energy consumption for such communications in these devices.

One strategy to minimize energy consumption is to turn the power off to the communication block as much/often as possible while maintaining data transmission and reception—without a corresponding increase in latency. Ideally the system could power on the communications block only when there is data to transmit and wake-up the communications block just before data reception, and power off the communications block for the remainder of the time.

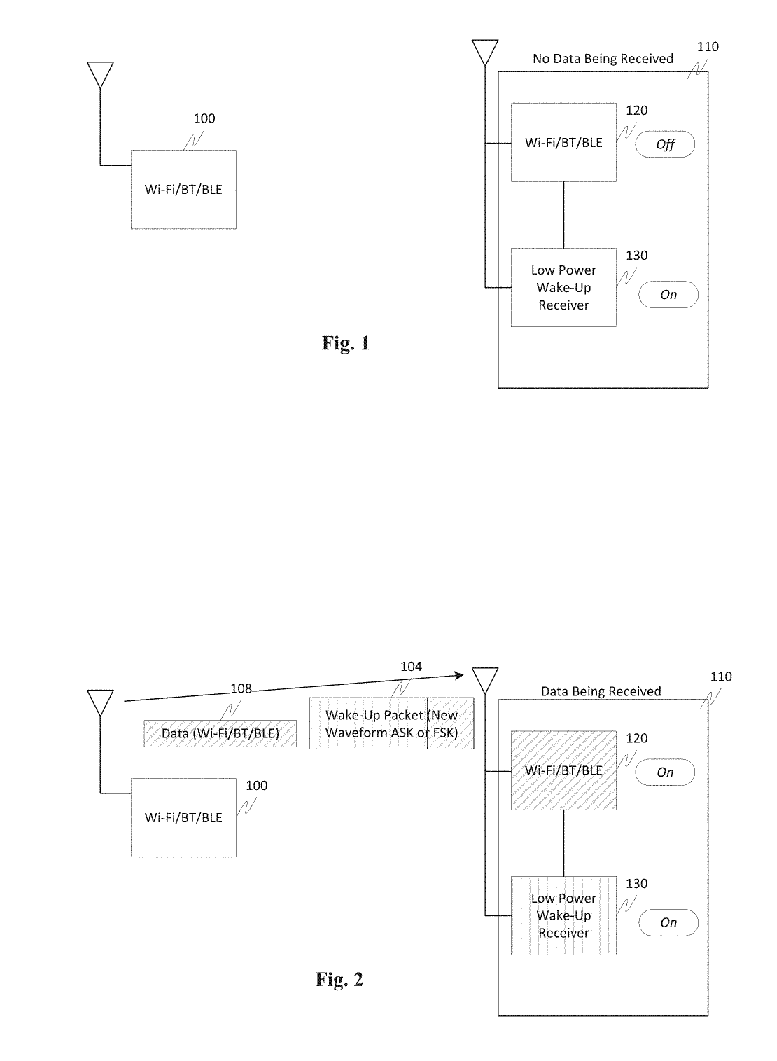

To address this issue, a radio architecture in which a specially designed low-power (e.g., with ˜50 μW active power or less) wake-up radio (LP-WUR) is used along with a main wireless radio (e.g., Wi-Fi, BT and/or BLE). Here the “main” radio wakes up only when the main radio has data to send to or receive from another radio (e.g., a Wi-Fi AP), as shown in FIG. 1. For example, when the Wi-Fi device 110 (e.g., smartphone) has data to send to the AP 100, the Wi-Fi device will send a wake-up signal, which in turn wakes up the main radio.

The low-power wake-up radio (LP-WUR) is a promising technique to significantly reduce the power consumption of a main wireless radios (e.g., Wi-Fi, Bluetooth, LTE, etc.) by removing the need for the main radio to periodically wake up to check if there is data to receive. As shown in FIG. 1, the LP-WUR allows a very low power method/technology to activate a main radio(s) only when there is data being sent specifically targeting that radio/device. The main radio could be any currently known radio, Wi-Fi, Bluetooth®, LTE, 5G, etc., or any future developed radio.

One exemplary advantage of the LP-WUR technology in that it helps with minimizing/reducing power consumption by one or more radios through use of the low-power wake-up radio.

An exemplary target device that can use the proposed technology is a device where a main radio is a radio that is capable of, for example, higher data rates than that of the LP-WUR, and typically consumes more power. This radio will henceforth be referred to as the “main” radio for explanation purposes.

As illustrated in FIGS. 1 and 2, one way to realize this operational transmit/receive strategy is to have a low-power wake-up receiver/radio (LP-WUR) that can wake-up the main radio, such as a Wi-Fi, Bluetooth® radio, BLE radio, only when there is data to receive/transmit. (See FIG. 1 where the Wi-Fi/BT/BLE radio 120 (main radio) is off and the low power wake-up receiver 130 is on with no data being received from device 100). Research suggests the power consumption of such low-power wake-up radios (LP-WUR) can be less than 50 microwatts as discussed above.

However, in FIG. 2, when a wake-up packet 104 is received from the AP 100, the LP-WUR 130 wakes-up the Wi-Fi/BT/BLE radio 120, so that a data packet 108 that follows the wake-up packet from the AP can be received correctly. In some cases however, the actual data or an IEEE 802.11 MAC frame can be included in the wake-up packet. In this case, there is no need to wake-up the whole Wi-Fi/BT/BLE radio, but just a portion of the Wi-Fi/BT/BLE radio needs to be woken up to do the necessary processing. This can lead to additional significant power savings.

An exemplary structure for transmission of a wake-up packet within the IEEE 802.11ax OFDMA structure has been proposed. In order to multiplex the transmission of wake-up signals with IEEE 802.11ax packets, the transmitter (e.g., AP) needs to allocate a sub-channel to the LP-WUR receiver along with an allocation of sub-channels for IEEE 802.11ax receivers. The IEEE 802.11ax draft specification requires alignment of the ends of packets from/to stations as stated below:
The transmission for all the STAs in a DL MU (MIMO, OFDMA) PPDU shall end at the same time. The transmission from all the STAs in an UL MU PPDU shall end at the time indicated in Trigger frame. The A-MPDU padding per each STA follows the 11ac procedure.

It is evident that the above required padding is an inefficient use of spectrum, although needed to maintain an indication of a busy medium for 3rd party stations that perform channel sensing.

One exemplary technique disclosed herein takes advantage of the above required padding and re-utilizes the padded area for transmission of wake-up packets.

There have been described methods to transmit and receive wake-up signals using OFDMA sub-cannels between a wake-up transmitter (e.g., Wi-Fi AP) and a receiver (e.g., STA with main radio and LP-WUR receiver). The AP transmitter, main radio and receiver can first negotiate and agree on parameters for the LP-WUR receiver operation, such as center frequency, bandwidth, etc., before the main radio enters the low-power wake-up mode (i.e., the main radio is off and LP-WUR is on). Then, the LP-WUR receiver will monitor the channel for a wake-up signal in a pre-negotiated location or center frequency (e.g., OFDMA sub-channel) and the AP transmitter (or Master transmitter) will schedule a wake-up signal transmission in the same frequency band. Also note that LP-WUR could also enter into a sleep mode for a scheduled amount of time and then wake to start monitoring the channel. However, in order to transmit a wake-up signal, the transmitter (e.g., AP) allocates a sub-channel (which is negotiated between the AP and STA before the STA entered the wake-up mode) to the LP-WUR receiver exclusively—this in combination with the above standard requirements results in an underutilized padding portion of the packet.

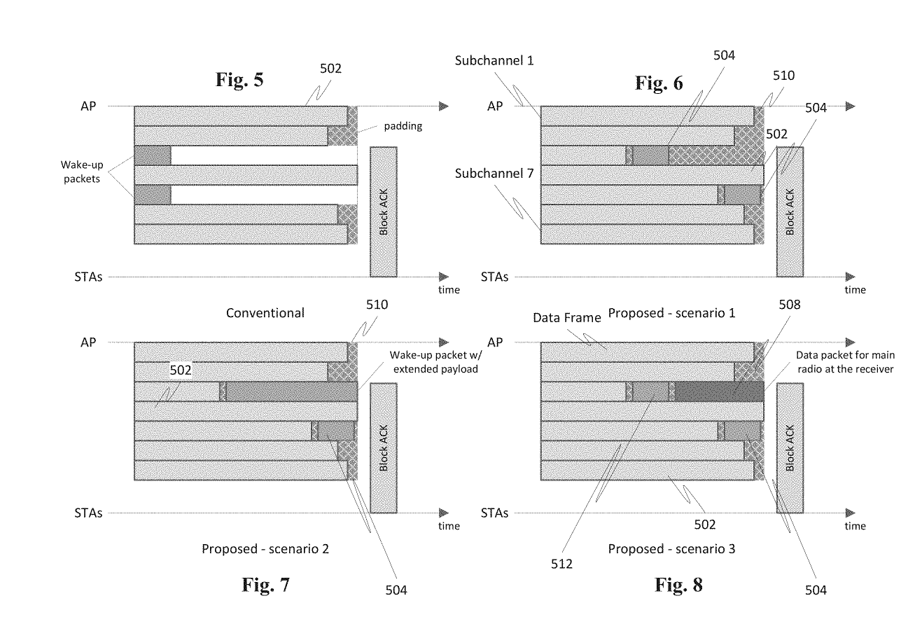

One exemplary aspect outlines methods to opportunistically schedule and transmit wake-up signals/information (and potentially data to the main radio once it is activated using the wake-up signal) with a legacy OFDMA packet in the time domain in the same sub-channel—when the time duration that needs padding is sufficient to transmit a wake-up packet (see exemplary FIGS. 6-10). By doing this, the transmitter (e.g., AP) can avoid unnecessary overhead in scheduling wake-up packet transmission and may improve spectrum efficiency. For this, one exemplary technique exploits the fact that the LP-WUR receivers do not attempt to detect (or care about) the legacy Wi-Fi OFDM/OFDMA signals which have arrived before and/or after a wake-up signal. The LP-WUR receiver can treat those legacy IEEE 802.11 signals as “noise,” and thus their presence will not affect the performance of the wake-up detection accuracy.

The IEEE 802.11ax draft specification requires alignment of end-of-packet OFDMA transmissions (See for examples FIGS. 5-9). Moreover, existing mechanisms schedule wake-up packets exclusively using a dedicated OFDMA resource unit (RU) (or sub-channel), which may leave a padding area for both the wake-up packet and IEEE 802.11ax transmissions.

By time-division multiplexing wake-up packets with other OFDMA packet transmissions, the AP can better reuse the padding area, which can be more efficient than allocating dedicated sub-channel(s) for wake-up signals.

IEEE 802.11ax APs can implement complex scheduling algorithms to minimize the padding area (e.g., by scheduling users with similar PPDU length). Therefore, multiplexing wake-up signals in time with OFDMA transmissions can provide one more degree of freedom to the AP when grouping/scheduling users.

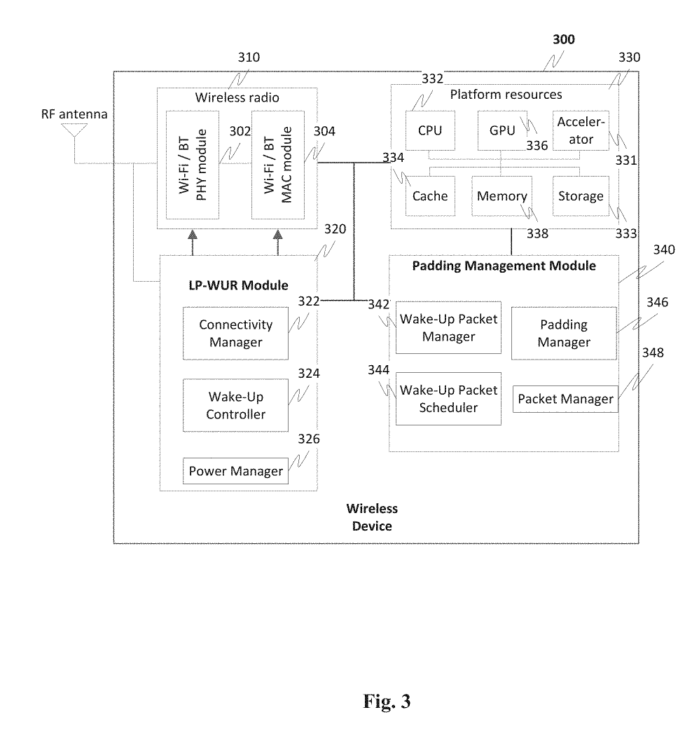

FIG. 3 illustrates an exemplary functional block diagram of a wireless device 300, such as a mobile device, that can be used with any one or more of the aspects disclosed herein. In particular, this exemplary architecture, where well-known components have been omitted for clarity, allows the LP-WUR module 320 to one or more of improve connectivity management and save power in the device 300 and optionally in one or more various platform resources 330.

More specifically, FIG. 3 illustrates an exemplary wireless/mobile device 300 that includes a wireless radio 310, which includes a Wi-Fi/Bluetooth® (BT)/BLE PHY module 302, a Wi-Fi/BT/BLE MAC module 304, an LP-WUR module 320, and one or more interconnected platform resources 330, such as CPU 332, cache 334, GPU 336, memory 338, accelerator 331 and storage 333.

In addition, the wireless/mobile device 300 includes a connectivity manager 322, a wake-up controller 324 and a power manager 326. The wireless/mobile device 300 also includes a padding management module 340 which includes a wake-up packet manager 342, a wake-up packet scheduler 344, a padding manager 346 and a packet manager 348. The mobile device 300 can also include one or more sensors (not shown) such as an accelerometer, gyroscope, GPS, Wi-Fi location determination module, and in general any device(s) capable of determining a position or change in position of the device.

In accordance with one exemplary embodiment, the presence of the LP-WUR is leveraged to one or more of improve latency and reduce power consumption. More specifically, the LP-WUR module 320 maintains connectivity to the AP without waking up the main radio 310. The AP can transmit wake-up packets with partial beacon information to the associated stations equipped with LP-WURs. When the wake-up packets are periodically received, the station “knows” that the AP is still within transmission range. Otherwise, if the periodic wake-up packets are not received, the station “knows” or detects that the AP is outside of the transmission range with this information being communicable to the main wireless radio 310 by the wake-up controller 324 and connectivity manager 322. This allows the power manager 326 to keep the main radio 310 in a sleep state, or turned off, for a longer period of time and maximize the radio/platform power saving without risking disconnection from the AP for a longer period of time.

As discussed herein, example DL (downlink)-OFDMA packet transmissions with and without the proposed mechanisms/techniques are provided. One exemplary aspect allows the AP to “opportunistically” time-multiplex wake-up packets within OFDMA transmissions by efficiently using the underutilized part of PPDUs, which otherwise will be filled with padding. As mentioned above, the DL OFDMA transmissions have to be completed at the same time. Thus, the padding management module 340 cooperates with one or more of the wake-up packet manager 342, wake-up packet scheduler 344, padding manager 346, packet manager 348 and a controller/processor to time-multiplex wake-up packets within OFDMA transmissions by using and inserting the wake-up packets in the underutilized part of PPDUs which otherwise will be filled with padding—which can negatively affect spectrum efficiency.

In accordance with one exemplary embodiment, where the wireless device can be an AP, the packet manager 348 and padding manager 346 know the length of the entire packet (including padding) and the length of its PPDU (without padding) as well as the duration of packet extension. Therefore, an IEEE 802.11ax receiver will stop its processing once it reaches to the end of the data packet, and 802.11ax STAs (receivers) are unaware and unaffected as to whether the padded area is actual padding or a wake-up packet introduced by the wake-up packet manager 342 because 802.11ax STAs will not process them. One main reason for padding is to keep the average power measured at a 3rd party station at the same level for the entire duration of transmission. Therefore, from the 3rd party station's perspective, embedding wake-up packets by the wake-up packet manager 342 and wake-up packet scheduler 344 in one or more padded portions prevents 3rd party stations from falsely assuming the medium is idle and accessing the channel.

Details regarding the insertion of the operation of device 300 will be described in greater detail with reference to FIGS. 6-9.

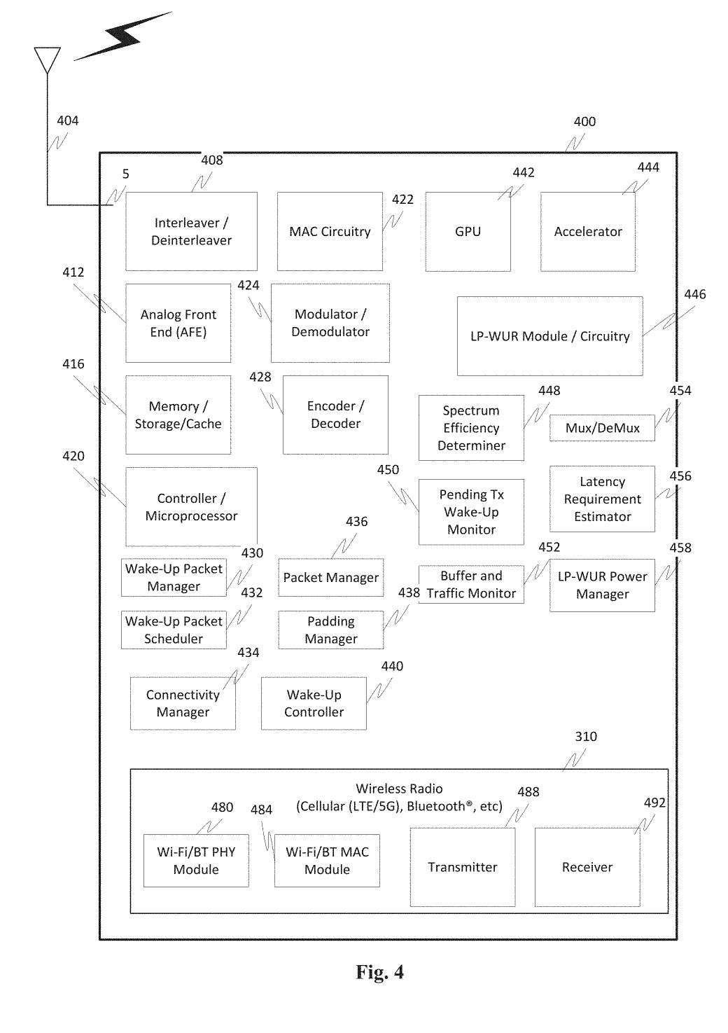

FIG. 4 illustrates an exemplary hardware diagram of a device 400, such as a wireless device, mobile device, access point, station, or the like, that is adapted to implement the technique(s) discussed herein.

In addition to well-known componentry (which has been omitted for clarity), the device 400 includes interconnected elements including one or more of: one or more antennas 404, an interleaver/deinterleaver 408, an analog front end (AFE) 412, memory/storage/cache 416, controller/microprocessor 420, MAC circuitry 422, modulator/demodulator 424, encoder/decoder 428, a wake-up packet manager 430, a wake-up packet scheduler 432, a connectivity manager 434, a packet manager 436, a padding manager 438, a wake-up controller 440, GPU 442, accelerator 444, a LP-WUR module and/or circuitry 446, a spectrum efficiency determiner 448, a pending transmission wake-up monitor 450, a buffer and traffic monitor 452, a multiplexer/demultiplexer 454, a latency requirement estimator 456, a LP-WUR power manager 458, and wireless radio 310 components such as a Wi-Fi PHY module 480, a Wi-Fi/BT MAC module 484, transmitter 488 and receiver 492. The various elements in the device 400 are connected by one or more links (not shown, again for sake of clarity).

The device 400 can have one more antennas 404, for use in wireless communications such as multi-input multi-output (MIMO) communications, multi-user multi-input multi-output (MU-MIMO) communications Bluetooth®, LTE, etc. The antenna(s) 404 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 404 generally interact with the Analog Front End (AFE) 412, which is needed to enable the correct processing of the received modulated signal and signal conditioning for a transmitted signal. The AFE 412 can be functionally located between the antenna and a digital baseband system in order to convert the analog signal into a digital signal for processing and vice-versa.

The device 400 can also include a controller/microprocessor 420 and a memory/storage/cache 416. The device 400 can interact with the memory/storage/cache 416 which may store information and operations necessary for configuring and transmitting or receiving the information described herein. The memory/storage/cache 416 may also be used in connection with the execution of application programming or instructions by the controller/microprocessor 420, and for temporary or long term storage of program instructions and/or data. As examples, the memory/storage/cache 420 may comprise a computer-readable device, RAM, ROM, DRAM, SDRAM, and/or other storage device(s) and media.

The controller/microprocessor 420 may comprise a general purpose programmable processor or controller for executing application programming or instructions related to the device 400. Furthermore, the controller/microprocessor 420 can perform operations for configuring and transmitting information as described herein. The controller/microprocessor 420 may include multiple processor cores, and/or implement multiple virtual processors. Optionally, the controller/microprocessor 420 may include multiple physical processors. By way of example, the controller/microprocessor 420 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 400 can further include a transmitter 488 and receiver 492 which can transmit and receive signals, respectively, to and from other wireless devices and/or access points using the one or more antennas 404. Included in the device 400 circuitry is the medium access control or MAC Circuitry 422. MAC circuitry 422 provides for controlling access to the wireless medium. In an exemplary embodiment, the MAC circuitry 422 may be arranged to contend for the wireless medium and configure frames or packets for communicating over the wireless medium.

The device 400 can also optionally contain a security module (not shown). This security module can contain information regarding but not limited to, security parameters required to connect the device to an access point or other device or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

As shown in FIG. 4, the exemplary device 400 also includes a GPU 442, an accelerator 444, a LP-WUR module and/or circuitry 446 a Wi-Fi/BT/BLE PHY module 480 and a Wi-Fi/BT/BLE MAC module 484 that at least cooperate with the LP-WUR module 446 and one or more of the spectrum efficiency determiner 448, pending transmission wake-up monitor 450, buffer and traffic monitor 452, mux/demux 454, latency requirement estimator 456, wake-up packet manager 430, wake-up packet scheduler 432, connectivity manager 434, packet manager 436, padding manager 438 and wake-up controller 440 to achieve at least the more efficient operation as discussed herein.

FIGS. 5-9 illustrate exemplary DL-OFDMA packet transmissions with and without the mechanisms proposed herein. As discussed, one exemplary embodiment allows, for example, an AP to “opportunistically” time-multiplex wake-up packets within OFDMA transmissions by efficiently using an up to this point underutilized part of PPDUs which would otherwise be filled with padding. As mentioned in the above and as can be seen in the figures, the DL OFDMA transmissions complete at the same time before the Block ACK.

The conventional approach is shown in FIG. 5 which exclusively allocates a sub-channel (or RU (Resource Unit)) for wake-up packet transmission (See subchannels 2 and 4 with the wake-up packets) (Also note the padding portion at the end of the data portion of the packets). This technique may result in a loss of spectrum efficiency, especially when DL (down link) IEEE 802.11ax packet transmissions are long, e.g., A-MPDU (aggregated-MPDU).

Exemplary proposed approaches shown in FIGS. 6-9 allow time-multiplexing the wake-up packets and potentially additional data for the main radio after the IEEE 802.11ax data packet transmissions. If needed, a payload portion of the wake-up packet can be extended to the end of the DL OFDMA transmission duration, as shown in FIG. 7.

The transmitter can also transmit data to the main radio followed by the wake-up packet, as shown in FIG. 8. Regarding the block 508 in FIG. 8, this block can be a separate 2 MHz (or equivalent to the size of OFDMA sub-channel bandwidth, e.g., 1 MHz, 4 MHz, etc.) 802.11 OFDM packet (PPDU) starting with its STF (Short Training Field). For the scenarios where the IEEE 802.11 OFDM packet is followed by the wake-up packet as shown in FIG. 8, the assumption could be that the receiver is tuned to that 2 MHz sub-channel after it is woken up by the wake-up receiver. The wakeup packet 512 could indicate that a 2 MHz OFDM packet 508 is following the wake-up packet 512.

As discussed above, some exemplary potential allocation options for a wake-up signal, e.g., 1 MHz, 2 MHz, 4 MHz, etc., are provided. Another option is to use a number of tones or sub-carriers, e.g., 13, 26, 52, etc., to indicate the sub-channel bandwidth allocation.

As one example, the allocation can be stated as 2 MHz and 26 tones (24 data 2 pilot) of a 20 MHz signal using a 256 point FFT (subcarrier spacing of 20 MHz/256).

As another example of an allocation, the allocation could be stated as a signal that is less than 20 MHz, and examples are 1 MHz, 2 MHz,4 MHZ, etc., . . . . Or stated another way, say examples are 13 subcarriers, 26, 32, or other subcarrier allocations (from a 256 FFT in 20 MHz).

These allocations could also vary based on the implementation, such as whether the wake-up radio is based on IEEE 802.11ah or IEEE 802.11ax, etc. So the allocations could be stated as (13 subcarriers 1 MHz), 26, 52, 106, etc., from a 256 point FFT in 20 MHz.

More specifically, and contrasted with the conventional OFDMA transmissions, of FIG. 5, new exemplary DL OFDMA transmissions as shown in FIGS. 6-9 are provided. In the diagrams, blocks 502 denote IEEE 802.11 packet transmissions, blocks 504 denote wake-up packet transmissions, and block 508 denotes a data packet for transmission to the main radio (after woken up by the wake-up packet 504 and the wake-up controller 440 and LP-WUR power manager 458). The patterned area 510 indicates padding.

In accordance with one exemplary embodiment, an IEEE 802.11ax STA, with the cooperation of the packet manager 436, padding manager 438 and connectivity manager 434, knows the length of the entire packet (including padding) and the length of its PPDU (without padding) as well as the duration of packet extension (if any).

The 802.11ax receiver will stop processing once the receiver reaches to the end of the data packet, and other IEEE 802.11ax STAs (receivers) are unaware and unaffected regardless of whether the padded area is actual padding (in accordance with the standard), or a wake-up packet (according to aspects discussed herein), since the other IEEE 802.11ax STAs will not process the wake-up packets.

One exemplary reason for the padding as discussed is to keep the average power measured at a 3rd party STAs at the same level for the entire transmission duration. Therefore, from the 3rd party STAs perspective, embedding wake-up packets within the padding portion(s) have no effect and also prevent the 3rd party STAs from falsely assuming the medium is idle and prematurely accessing the channel.

In exemplary FIG. 6, the wake-up packets are placed at the ends of data packets of sub-channels 2 and 4, respectively. In FIG. 7, a wake-up packet with an extended payload is shown for a first sub-channel, and wake-up packet without an extended payload shown on another sub-channel. FIG. 8 shows a wake-up packet followed by a data packet for the main radio on a first sub-channel, and a second wake-up packet on another sub-channel. While the various wake-up packets are shown on specific sub-channels, it is to be appreciated that the various configurations shown in FIGS. 6-9 can be rearranged and/or combined in any order and/or configuration on any one or more sub-channel(s).

Wake-up Packet Scheduling

One constraint in scheduling wake-up packets by the wake-up packet scheduler 432 is that the wake-up receiver is typically waiting for a wake-up packet at a fixed sub-channel location, which is pre-negotiated with the transmitter (AP) before the STA enters the wake-up mode.

Therefore, for a given sub-channel, the transmitter, and in particular the wake-up packet scheduler 432, wake-up packet manager 430 and packet manager 436, should decide whether to schedule a wake-up packet(s) (if present), IEEE 802.11 data packet(s), or both. Alternatively, scheduling algorithms within the wake-up packet scheduler 432 can cooperate with the packet manager 436 in the transceiver to adjust the resource (sub-channel) allocation of other data packets. In scheduling, the transceiver/device may use the following exemplary non-limiting performance metrics, or combinations thereof, in scheduling the wake-up packet(s):

Spectrum efficiency—as determined by the spectrum efficiency determiner 448

Wake-up latency requirement—as determined by the latency requirement estimator 456

Number of pending wake-up transmissions—as determined by the pending transmission wake-up monitor 450

DL buffer and traffic statistics—as determined by the buffer and traffic monitor 452

UL scheduling requests and traffic statistics—as determined by the buffer and traffic monitor 452

The transmitter 488 may transmit one or more wake-up packets, and potentially data to the main radio on the same sub-channel within a single DL OFDMA transmission in order to improve spectrum efficiency and minimize latency in wake-up packet transmissions. For example, if an AP needs to wake-up both STA A and STA B, which are in a wake-up mode waiting for a wake-up packet on the same sub-channel, then the AP may schedule and transmit wake-up packets for both STAs within a single DL OFDMA transmission.

Adjacent Channel Interference (ACI)

In accordance with another exemplary aspect, there could be deployment scenarios based on hardware complexity, device location, etc., where the transmitter may need to null adjacent sub-channels during wake-up packet transmissions depending on, for example, a LP-WUR receiver's adjacent channel interference (ACI) requirements.

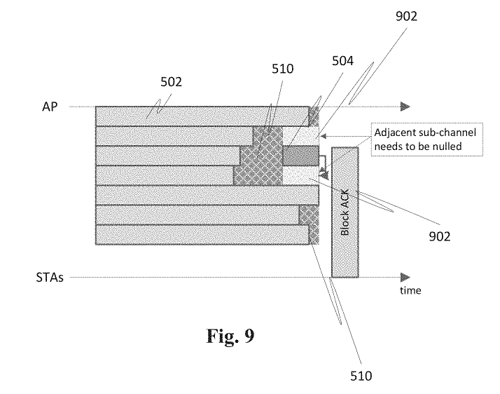

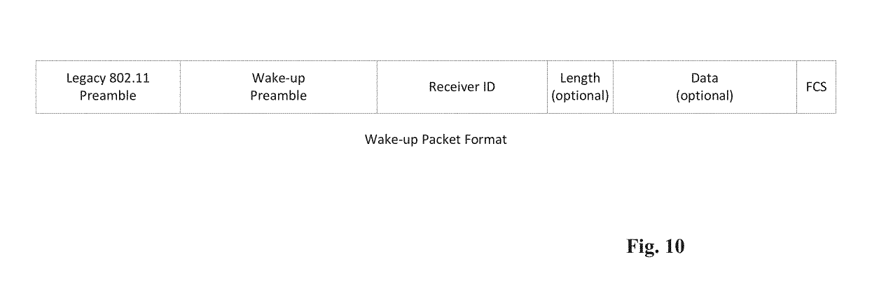

For example, LP-WUR receiver at STA A may require one or more adjacent sub-channels to be nulled for reliable reception of a wake-up signal. FIG. 9 shows an example scenario where wake-up packet transmission requires adjacent two sub-channels 902 to be nulled. The exemplary wake-up packet transmission shows adjacent sub-channels which are not padded for a reliable transmission/reception of the wake-up packet.

The system can optionally consider such requirements when scheduling wake-up packet transmissions in conjunction with the wake-up packet scheduler 432. Such ACI requirements can also optionally be shared between the AP and the STA(s) during the initial capability exchange phase.

In this scenario, the system will not add padding to the end of adjacent sub-channels 902 during the wake-up signal transmission 504. The system can increase the transmit power of the wakeup packet 504 so that an overall power level observed at 3rd party STAs in adjacent sub-channels during the wake-up packet transmission is approximately same as the other part of the OFDMA signal.

Also, the transmitter can advertise the length of the entire packet (using, for example, the LENGTH and RATE fields in the packet PHY header) including the padding and nulled spaces to the receiver and 3rd party STAs. The above actions can (i) allow the receiver to wait until the end of DL OFDMA transmission before sending an ACK back to the transmitter, and (ii) prevent the 3rd party STAs from mis-detecting the medium (the adjacent sub-channels) as idle during the wake-up signal transmission.

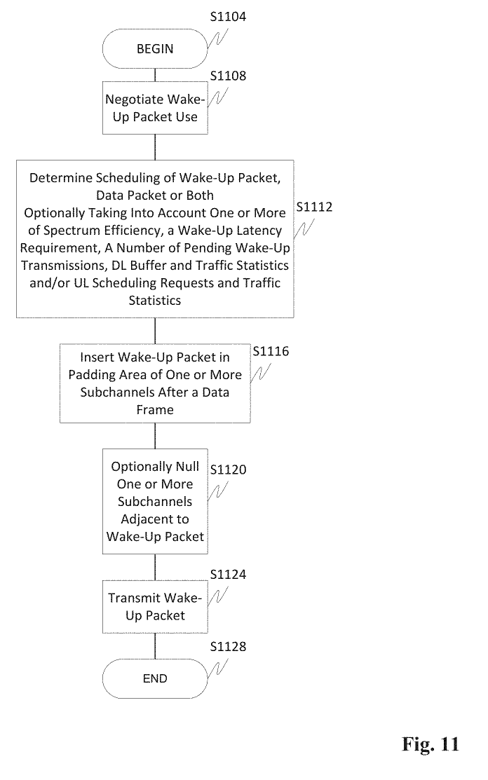

FIG. 10 shows an exemplary wake-up packet format. The packet (e.g., 504 as shown in FIGS. 6-9) can include a legacy preamble, a wake-up preamble, a receiver ID, an optional length portion, an optional data portion and a FCS. As is to be appreciated, the various fields are optional and the packet can of course include additional fields as needed.

FIG. 11 is a flowchart illustrating an exemplary method for re-utilizing a padding portion of one or more subchannels after an OFDMA data packet transmission. Control begins in step S1104 and continues to step S1108. In step S1108, a first device negotiates the use of the wake-up packets(s) with at least a second device. Next, in step S1112, it is determined by, for example, an AP, the scheduling of a wake-up packet, a data packet or both. This scheduling can optionally take into account one or more of spectrum efficiency, a wake-up latency requirement, a number of pending wake-up transmissions, a downlink (DL) buffer and traffic statistics and/or uplink (UL) scheduling requests and traffic statistics or the like. Then, in step S1116, a wake-up packet is inserted in a padding area of one or more subchannels after a data frame. Control then continues to step S1120.

In step S1120, one or more subchannels adjacent to the wake-up packet can optionally be nulled. Optionally still, one or more other channels not adjacent to the wake-up packet could be nulled. In accordance with one exemplary embodiment, the nulling could be different for each station, with the nulling optionally also being negotiated as part of the wake-up packet use. Next, in step S1124, the wake-up packet is transmitted with control continuing to step S1128 where the control sequence ends.

It should be appreciated, the various power management schemes discussed herein can have their specific features interchanged with one or more of the other power management schemes to provide, for example, further power savings, to alter/improve latency and/or alter platform functionality. While the techniques discussed herein have been specifically discussed in relation to IEEE 802.11 systems, it should be appreciated that the techniques discussed herein can generally be applicable to any type of wireless communication standard, protocol, and/or equipment. Moreover, all the flowcharts have been discussed in relation to a set of exemplary steps, it should be appreciated that some of these steps could be optional and excluded from the operational flow without affecting the success of the technique. Additionally, steps provided in the various flowcharts illustrated herein can be used in other flowcharts illustrated herein.

It is to also be understood that when it is discussed that the whole Wi-Fi/BT/BLE radio is to be turned on/off, it can be one or more of the Wi-Fi, Bluetooth®, and Bluetooth® Low Energy radio(s) that are turned on/off and if the device has all three radios, they need not all be turned on/off but optionally only the radio(s) that is needed.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links 5, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to power control in a wireless transceiver. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:
A wireless communications device comprising:
   a wake-up packet scheduler;
   a packet manager; and
   a padding manager, the wake-up packet scheduler, packet manager and padding manager cooperating to insert at least one wake-up packet on a sub-channel in a padding area after a data frame, the wake-up packet usable by a low-power wake-up radio.
Any of the above aspects, further comprising one or more of a transmitter, a receiver, an interleaver/deinterleaver, an analog front end, a modulator/demodulator, a GPU, an accelerator, an encoder/decoder, one or more antennas, a processor and memory.
Any of the above aspects, further comprising one or more of a spectrum efficiency determiner, a pending transmission wake-up monitor, a buffer and traffic monitor, a multiplexer/demultiplexer and a latency requirement estimator.
Any of the above aspects, further comprising one or more wireless radios.
Any of the above aspects, wherein one or more sub-channels are nulled with the wake-up packet.
Any of the above aspects, wherein one or more adjacent sub-channels are nulled with the wake-up packet.
Any of the above aspects, further comprising a wake-up controller configured to control operation of a main radio.
Any of the above aspects, wherein one or more adjacent subchannels are nulled on a station-centric basis.
Any of the above aspects, further comprising a low-power wake-up radio power manager configured to control operation of a low-power wake-up radio based on the wake-up packet.
Any of the above aspects, configured to one or more of save power, improve spectrum efficiency and improve latency at least based on the wake-up packet.
A non-transitory computer-readable information storage media, having stored thereon instructions, that when executed by a processor perform a wireless communication method comprising:
   negotiating wake-up packet use;
   determining scheduling of at least one wake-up packet; and
inserting at least one wake-up packet on a sub-channel in a padding area after a data frame, the wake-up packet usable by a low-power wake-up radio of a wireless communication device.
Any of the above aspects, wherein the wireless communications device comprises one or more of a transmitter, a receiver, an interleaver/deinterleaver, an analog front end, a modulator/demodulator, a GPU, an accelerator, an encoder/decoder, one or more antennas, a processor and memory.

Any of the above aspects, further comprising one or more of determining spectrum efficiency, monitoring pending wake-up transmissions, monitoring a buffer, monitoring traffic, and estimating a latency requirement.
Any of the above aspects, wherein the wireless communication device comprises one or more wireless radios.
Any of the above aspects, further comprising nulling one or more sub-channels with the wake-up packet.
Any of the above aspects, further comprising nulling one or more adjacent sub-channels with the wake-up packet.
Any of the above aspects, further comprising controlling operation of the main radio.
Any of the above aspects, further comprising controlling operation of a low-power wake-up radio based on the wake-up packet.
Any of the above aspects, further comprising nulling one or more adjacent subchannels on a station-centric basis.
Any of the above aspects, further comprising one or more of saving power, improving spectrum efficiency and improving latency at least based on the wake-up packet.
A wireless communications device comprising:
   means for negotiating wake-up packet use;
   means for determining scheduling of at least one wake-up packet; and
means for inserting at least one wake-up packet on a sub-channel in a padding area after a data frame, the wake-up packet usable by a low-power wake-up radio of a wireless communication device.
Any of the above aspects, further comprising one or more of a transmitter, a receiver, an interleaver/deinterleaver, an analog front end, a modulator/demodulator, a GPU, an accelerator, an encoder/decoder, one or more antennas, a processor and memory.
Any of the above aspects, further comprising one or more of a spectrum efficiency determiner, a pending transmission wake-up monitor, a buffer and traffic monitor, a multiplexer/demultiplexer and a latency requirement estimator.
Any of the above aspects, further comprising one or more wireless radios.
Any of the above aspects, wherein one or more sub-channels are nulled with the wake-up packet.
Any of the above aspects, wherein one or more adjacent sub-channels are nulled with the wake-up packet.
Any of the above aspects, further comprising a wake-up controller configured to control operation of a main radio.
Any of the above aspects, wherein one or more adjacent subchannels are nulled on a station-centric basis.
Any of the above aspects, further comprising a low-power wake-up radio power manager configured to control operation of a low-power wake-up radio based on the wake-up packet.
Any of the above aspects, configured to one or more of save power, improve spectrum efficiency and improve latency at least based on the wake-up packet.
A wireless communications method comprising:
   negotiating wake-up packet use;
   determining scheduling of at least one wake-up packet; and
inserting at least one wake-up packet on a sub-channel in a padding area after a data frame, the wake-up packet usable by a low-power wake-up radio of a wireless communication device.
Any of the above aspects, wherein the wireless communications device comprises one or more of a transmitter, a receiver, an interleaver/deinterleaver, an analog front end, a modulator/demodulator, a GPU, an accelerator, an encoder/decoder, one or more antennas, a processor and memory.
Any of the above aspects, further comprising one or more of determining spectrum efficiency, monitoring pending wake-up transmissions, monitoring a buffer, monitoring traffic, and estimating a latency requirement.
Any of the above aspects, wherein the wireless communication device comprises one or more wireless radios.
Any of the above aspects, further comprising nulling one or more sub-channels with the wake-up packet.
Any of the above aspects, further comprising nulling one or more adjacent sub-channels with the wake-up packet.
Any of the above aspects, further comprising controlling operation of the main radio.
Any of the above aspects, further comprising controlling operation of a low-power wake-up radio based on the wake-up packet.
Any of the above aspects, further comprising nulling one or more adjacent subchannels on a station-centric basis.
Any of the above aspects, further comprising one or more of saving power, improving spectrum efficiency and improving latency at least based on the wake-up packet.
A method of using a wake-up packet in a wireless communications environment comprising:
   negotiating wake-up packet use;
   determining scheduling of at least one wake-up packet; and
inserting at least one wake-up packet on a sub-channel in a padding area after a data frame, the wake-up packet usable by a low-power wake-up radio of a wireless communication device to control wake-up of a main radio.
Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an IEEE 802.11 transceiver, or the like. Examples of wireless protocols that can be used with this technology include IEEE 802.11a, IEEE 802.11b, IEEE 802.11g, IEEE 802.11n, IEEE 802.11ac, IEEE 802.11ad, IEEE 802.11af, IEEE 802.11ah, IEEE 802.11ai, IEEE 802.11aj, IEEE 802.11aq, IEEE 802.11ax, Wi-Fi, LTE, 4G, Bluetooth®, WirelessHD, WiGig, WiGi, 3GPP, Wireless LAN, WiMAX, and the like.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARN926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA.®. or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for power management and/or use of wake-up packet(s) in a wireless device. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a wake-up packet scheduler;
a packet manager; and
a padding manager, the wake-up packet scheduler, packet manager and padding manager cooperating to insert at least one wake-up packet on a sub-channel in a padding area after a data frame, the wake-up packet usable by a low-power wake-up radio.

2. The device of claim 1, further comprising one or more of a transmitter, a receiver, an interleaver/deinterleaver, an analog front end, a modulator/demodulator, a GPU, an accelerator, an encoder/decoder, one or more antennas, a processor and memory.

3. The device of claim 1, further comprising one or more of a spectrum efficiency determiner, a pending transmission wake-up monitor, a buffer and traffic monitor, a multiplexer/demultiplexer and a latency requirement estimator.

4. The device of claim 1, further comprising one or more wireless radios.

5. The device of claim 1, wherein one or more sub-channels are nulled with the wake-up packet.

6. The device of claim 5, wherein one or more adjacent sub-channels are nulled with the wake-up packet.

7. The device of claim 1, further comprising a wake-up controller configured to control operation of a main radio.

8. The device of claim 6, wherein one or more adjacent subchannels are nulled on a station-centric basis.

9. The device of claim 1, further comprising a low-power wake-up radio power manager configured to control operation of a low-power wake-up radio based on the wake-up packet.

10. The device of claim 1, configured to one or more of save power, improve spectrum efficiency and improve latency at least based on the wake-up packet.

11. A non-transitory computer-readable information storage media, having stored thereon instructions, that when executed by a processor perform a wireless communication method comprising:
negotiating wake-up packet use;
determining scheduling of at least one wake-up packet; and
inserting at least one wake-up packet on a sub-channel in a padding area after a data frame, the wake-up packet usable by a low-power wake-up radio of a wireless communication device.

12. The media of claim 11, wherein the wireless communications device comprises one or more of a transmitter, a receiver, an interleaver/deinterleaver, an analog front end, a modulator/demodulator, a GPU, an accelerator, an encoder/decoder, one or more antennas, a processor and memory.

13. The media of claim 11, further comprising one or more of determining spectrum efficiency, monitoring pending wake-up transmissions, monitoring a buffer, monitoring traffic, and estimating a latency requirement.

14. The media of claim 11, wherein the wireless communication device comprises one or more wireless radios.

15. The media of claim 11, further comprising nulling one or more sub-channels with the wake-up packet.

16. The media of claim 15, further comprising nulling one or more adjacent sub-channels with the wake-up packet.

17. The media of claim 11, further comprising controlling operation of the main radio.

18. The media of claim 11, further comprising controlling operation of a low-power wake-up radio based on the wake-up packet.

19. The media of claim 11, further comprising nulling one or more adjacent subchannels on a station-centric basis.

20. The media of claim 11, further comprising one or more of saving power, improving spectrum efficiency and improving latency at least based on the wake-up packet.

21. A wireless communications device comprising:
means for negotiating wake-up packet use;
means for determining scheduling of at least one wake-up packet; and
means for inserting at least one wake-up packet on a sub-channel in a padding area after a data frame, the wake-up packet usable by a low-power wake-up radio of a wireless communication device.

22. A wireless communications method comprising:
negotiating wake-up packet use;
determining scheduling of at least one wake-up packet; and
inserting at least one wake-up packet on a sub-channel in a padding area after a data frame, the wake-up packet usable by a low-power wake-up radio of a wireless communication device.
